(19) United States
(12) Patent Application Publication
(10) Pub. No.: US 2003/0046794 A1
(43) Pub. Date: Mar. 13, 2003

(54) Reduced tolerance window support bracket

(76) Inventor: Malcolm Muir, Honeoye Falls, NY (US)

Correspondence Address: Stephen B. Salai, Esq., Harter, Secrest & Emery LLP, 1600 Bausch & Lomb Place, Rochester, NY, 14604-2711, US

(21) Appl. No.: 09/951,687

(22) Filed: Sep. 13, 2001

(51) Int. Cl. E05D 3/06

(52) U.S. Cl. 16/366

(57) ABSTRACT

A reduced tolerance window support bracket assembly is disclosed. The bracket includes a hinge with a vent bar having apertures to accept fasteners for engaging the hinge to a window sash. The apertures and the fasteners are configured to provide that the play between the window sash and a frame is optimized, thus avoiding the extremes of possible leakage and excessive pressure on a weather-strip.

### FIELD OF THE INVENTION

The present invention relates to window supporting brackets which are arranged to support a window for pivotal movement about either a vertical or a horizontal axis. More particularly, the present invention relates to a supporting bracket assembly providing an optimized adjustment tolerance.

### BACKGROUND OF THE INVENTION

Windows are a significant source of heat loss from buildings. Given the necessity to save costs and conserve energy, increasing attention is directed to improving the efficiency of windows. Much energy can be saved by such strategies as providing sealed double-paned windows and using low-E glass, much of the conservation realized thereby can be vitiated by inadequately sealed windows. While this is not a usually an issue with fixed windows, those that are intended to be opened lend themselves to the provision of more effective seals.

A common type of window consists typically of a rectangular frame set into a building wall and a corresponding pivotally movable vent. Such windows typically have supporting brackets to permit pivotal movement of the vent about a vertical axis or a horizontal axis, and are also adapted to be connected between a conventional window frame and window sash, whether these structures be formed of metal, wood, PVC, or other structural material. The brackets are typically arranged to cause the pivotal axis of the window to move to and from the window frame so that when the window is open, both surfaces are accessible from the inner side of the window.

As in other windows, weather-stripping must be interposed between the vent and the frame in order to provide an effective seal when the window is closed. The quality of the seal depends on a number of factors such as the clearance between the vent and the frame in terms of its actual value and the tolerance or “play” allowed, and the physical properties of the seal material. It is assumed that the weather-stripping is compliant enough to yield to pressure exerted by the vent. There must be sufficient play to allow for variability of the weather-stripping. For an optimum seal, the elements of the window must be in the closest possible contact with the weather-stripping while simultaneously not exerting excessive pressure thereon, which could lead to sticking.

U.S. Pat. No. 5,898,977. to Muir, discloses a supporting bracket or stay which can be used on a window. Although the supporting bracket disclosed therein substantially precludes sash play to an extent found in other prior art, the tolerance is nevertheless not optimized.

Accordingly, there is a need to provide a mechanism for optimizing the clearance between the vent and the frame, and the allowable play therebetween, so that the clearance is small enough to minimize leakage of air or water through the window, while there is enough play to avoid excessive pressure on the weather-stripping, which could cause sticking problems.

### SUMMARY OF THE INVENTION

A preferred embodiment supporting bracket assembly of the present invention includes a four bar hinge substantially as disclosed in U.S. Pat. No. 5,898,977, and a fastener configured to provide optimum positioning of the hinge relative to the window sash. The hinge includes a track for mounting to a frame; a vent bar for attaching to a window sash, the vent bar being hinged for movement on both sides of the centerline of the track, and having a centerline parallel and substantially in line with the centerline of the track when the supporting bracket is in a closed position; and structure, during an opening operation, for preventing the vent bar from crossing the centerline of the track in a direction opposite a direction of opening. The supporting bracket of the preferred embodiment is “non-handed”, that is, may be utilized on opposite sides of a window.

In any contemplated embodiment, a pair of apertures is provided in the vent bar, for accepting the fastener. The clearance the aperture provides between the vent bar and the fastener determines the amount of tolerance in the positioning of the vent bar relative to the sash and, therefore, how well the window seals against weather-stripping which is typically present.

The foregoing and other features and advantages of the invention will be more readily understood and fully appreciated from the following detailed description, taken in conjunction with the accompanying drawings.

### BRIEF DESCRIPTION OF THE DRAWINGS

FIG. 1 shows a side perspective view of a fully assembled supporting bracket in a closed position.

FIG. 2 shows a top plan view of the supporting bracket of the present invention in an open position.

FIGS. 3A and 3B show a perspective view of a portion of a vent bar in the process of engagement with a window sash using a fastener.

FIG. 4A shows a top plan view of a portion of a portion of the vent bar.

FIG. 4B shows a top plan view of the fastener.

FIG. 5 shows a top plan view of the mounting set-up of the window supporting bracket.

FIG. 6A and 6B represent schematically the play of a window sash relative to the vent bar.

### DETAILED DESCRIPTION OF THE PREFERRED EMBODIMENT

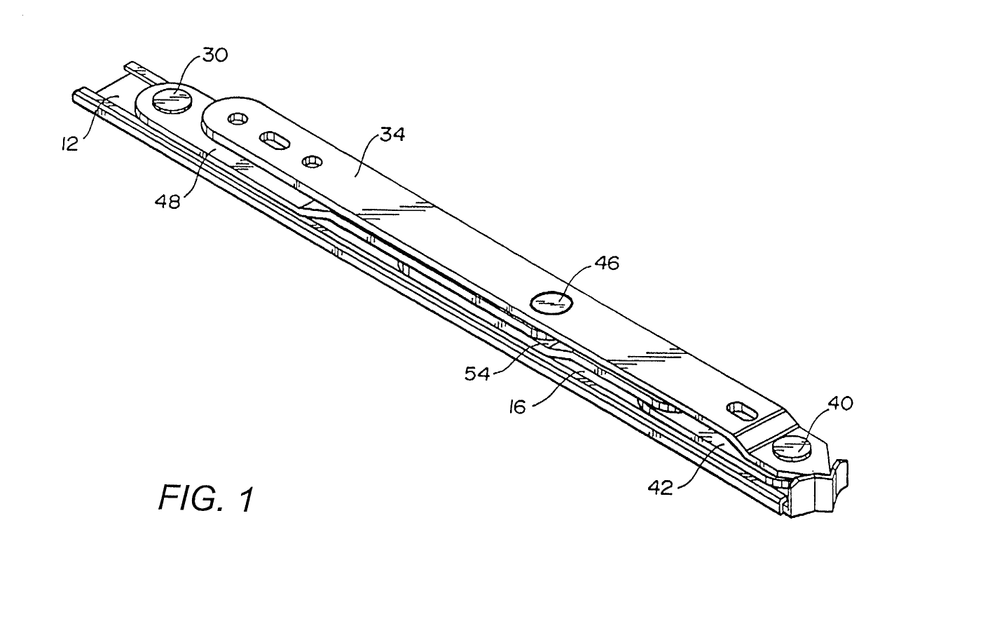

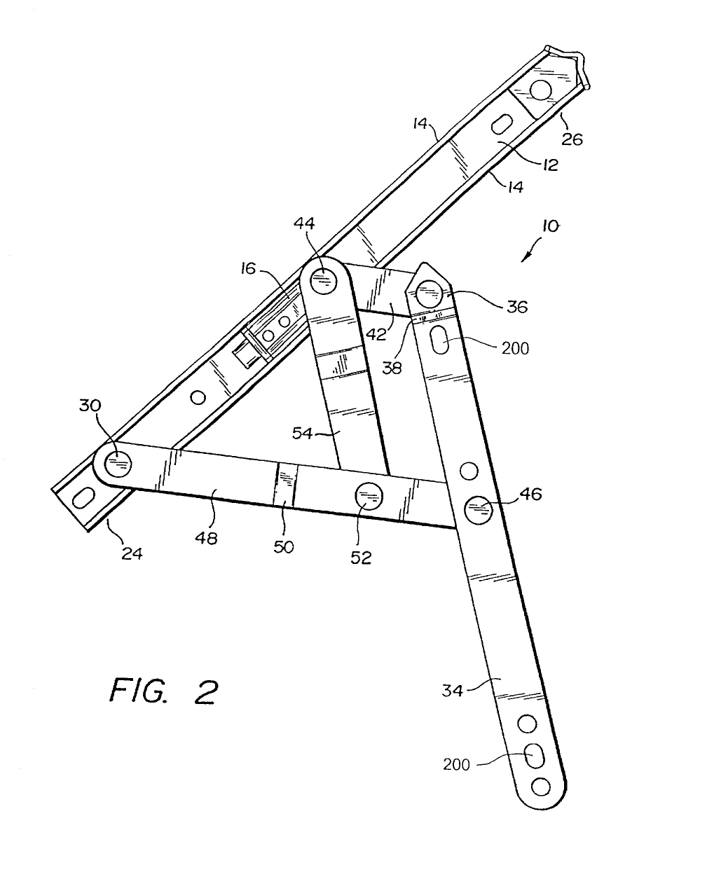

As shown in FIGS. 1 and 2, a supporting bracket 10 of the present invention may be positioned in a closed position or one of many open positions. A window sash 122 is frictionally restrained in any angular position to which the supporting bracket 10 is moved. This frictional restraint is provided by the friction between the various elements of the supporting bracket 10

The supporting bracket 10 may be positioned on any side of a window, and is generally provided in pairs. Each bracket 10 in the pair of brackets utilized to support a window includes a track member 12 having folded side flanges 14. The track member 12 is secured by screws (not shown) to a window frame 120, preferably with one end 26 of the track member 12 adjacent a corner of the window frame 120.

Mounted on the track member 12 is a slide 16 having side flanges 18 which fit under and are retained by the side flanges 14. The slide 16 is preferably a solid brass shoe for smooth, long-lasting performance. The slide 16 is provided with a shallow raised portion forming a cavity confronting the track 12.

The slide 16 is slidable between the end 26 of the track member 12, adjacent the comer of the window frame 120 and a position near the opposite or extended end 24. The end 24 of the track remote from the comer of the window frame 120 may be provided with a raised boss (not shown) extending to a level flush with the upper surfaces of the side flanges 14. The boss is provided with a pivot pin or rivet 30.

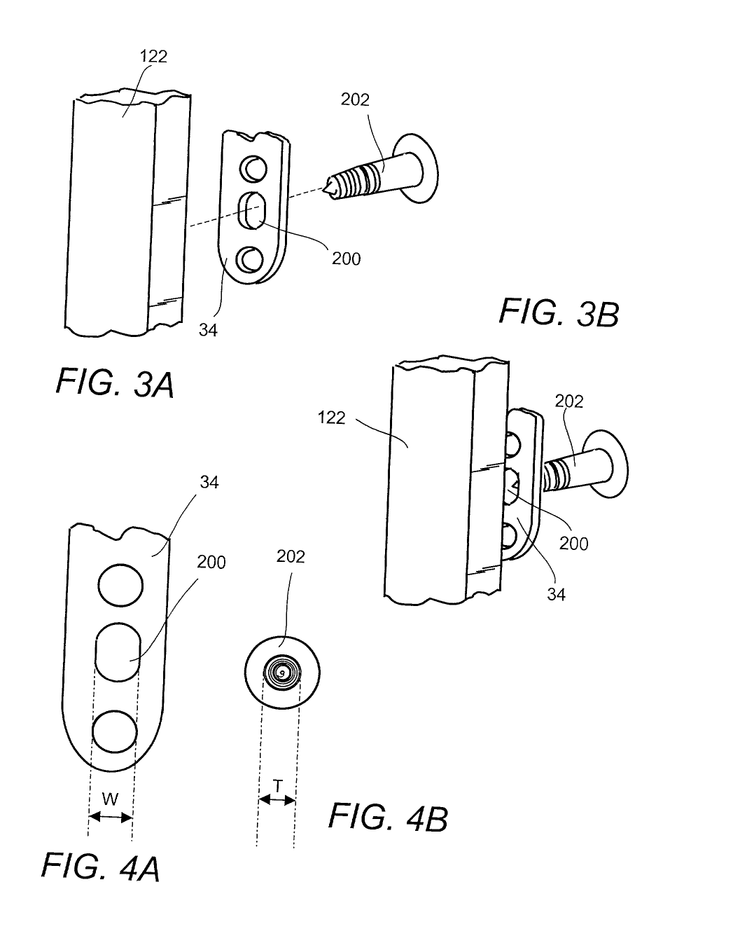

As best seen in FIGS. 3A and 3B, a substantially flat vent bar 34 is secured to the confronting side of the window sash 122 by fasteners such as screws 202 passing through mounting apertures 200 which are preferably elongate in the direction of the vent bar 34.

When the window sash 122 is in its closed position within the window frame 120, the bar 34 overlies or confronts the track 12 with one end 36 adjacent the end 26 of the track 12 disposed in the comer of the window frame 120. Near this end 36 of the bar 34, there is provided a downward offset 38 and pivot pin or rivet 40. A short link 42 is pivotally connected between the pivot pin 40 and a pivot pin 44 provided on top of the slide 16.

The bar 34 is provided with a second pivot pin 46. A strut 48 extends between the pivot pin 46 and the pivot pin 30 at the remote end 24 of the track 12. The pivot pin 46 is so located that when the bar 34 is in superposed relation with the track 12, the strut 48 is interposed between the track 12 and bar 34 and is in alignment with the bar 34. This is likewise true of the link 42.

A portion of the strut 48 is offset upwardly as indicated by 50. Within the length of the upwardly offset portion is a pivot pin 52. A brace 54 extends between the pivot pin 52 and the pivot pin 44 of the slide 16. The length of the link 42, between the pivot pins 40 and 44 and the length of the brace 54 between the pivot pins 44 and 52 combined are equal to the portion of the strut 48 between the pivot pins 52 and 46, plus the portion of the bar 34 between the pivot pins 46 and 40. The pivot pins 40, 44, 52, and 46 define a four-sided figure. The bar 34, link 42, strut 48, and brace 54 are preferably all made from stainless steel and are preferably provided with rounded edges. Together, the four elements 34, 42, 48, and 54 define what is known in the industry as a “four bar hinge”. Although only four bars, 34, 42, 48, and 54 are disclosed, it should be understood that additional bars may be included for heavier windows, such as a cross-link connecting the brace 54 to the bar 34.

It is desirable that the window sash 122 fit tightly against the window frame 120 when the window sash 122 is closed, but not so tightly as to excessively compress the weather-stripping. To this end, once the widow sash 122 and vent bar 34 are secured together by the screws 202 as indicated earlier, the alignment of the vent bar 34 and the window sash 122 is defined by the relationship between screws 202 and the mounting apertures 200, which have a length and a width, the latter being as indicated as W in FIG. 4A. As can be appreciated, the bar 34 can be translated along the sash 122 as permitted by the length. However, any sideways displacement is limited by the magnitude of the difference (W−T), where T is the screw diameter as indicated in FIG. 4B. It is most typical to use in such applications a no. 10 screw, for which T is nominally 0.185″ (4.70 mm).

In the present invention, W is selected to be no greater than 0.195″ (4.95 mm); in other words, the sideways clearance of the screw 202 in the mounting aperture 200, is no greater than 0.01″ (0.25 mm), which determines the play between the sash 122 and the frame 120. In percentage terms, the clearance represents no more than 5.1% of W. The 0.01″ clearance is less than the clearance of 0.03″ (0.75 mm) tolerated in prior art devices. In such devices, the mounting aperture rarely has a minimum diameter less than 0.219″ (5.56 mm) and never less than 0.215″ (5.46 mm), and the prior art clearance of a no. 10 screw is, therefore, 0.03″ (0.69 mm) or 14% of W.

A comparable tolerance could be achieved by using a no. 11 screw with the typical aperture width of prior art. In this case, W is in the range 0.215-0.219″ (5.46-5.56 mm) and T is 0.200″ (5.08 mm), leading to a clearance in the range 0.015-0.019″ (0.38-0.48 mm) which still a distinct improvement over prior art.

It is in fact quite unexpected that a low tolerance as disclosed herein should be an advantage, since it would be expected to place more exacting demands on the assembly of the window and to lead to sticking problems in the assembled window. Additionally, the larger tolerance familiar in prior art would be expected to be more consistent with the variety of available weatherproofing seals. On the contrary, it is now shown that the tolerance achieved in the present invention enables one to maximize the degree of weatherproofing while avoiding excessive compression of the weather-stripping between the sash 122 and the frame 120. Prior art devices with greater tolerance in fact risk on one extreme too much leakage and on the other extreme excessive compression of the weather-stripping which might cause sticking. The present invention avoids either extreme.

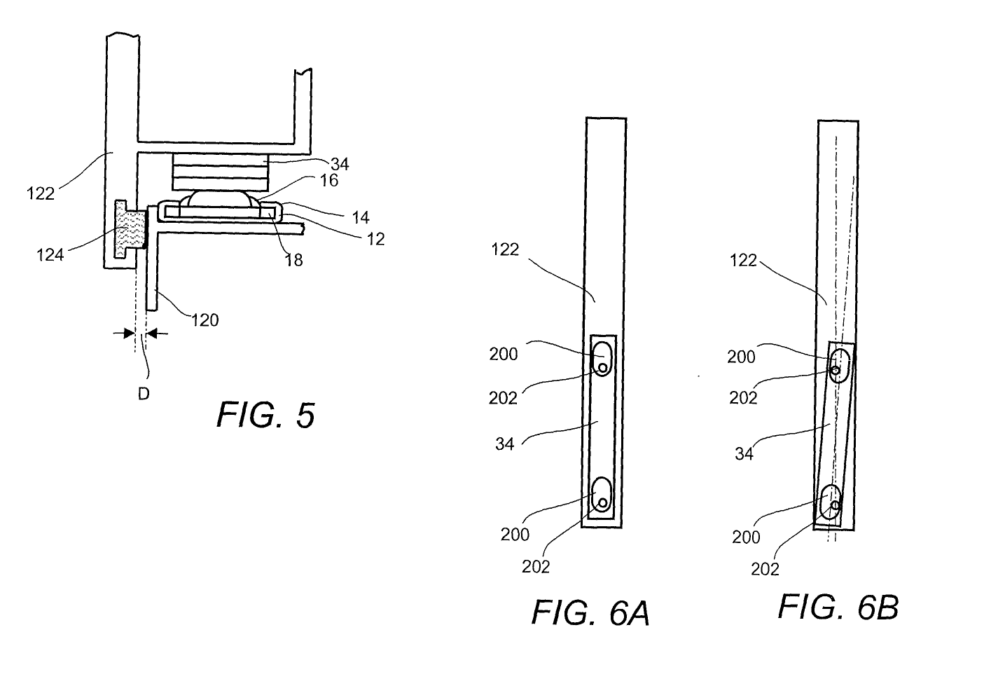

FIG. 5 illustrates a typical relationship between the sash 122, the support bracket 10 and the frame 120 in the closed position. The sash has a slotted opening for engaging a weather-strip 124 in an interlocking relationship, so that the weather-strip abuts the frame 120. The spacing between the frame 120 and the sash 122 is denoted as D in FIG. 5.

To assemble a window including the present invention, the track is attached to a predetermined position in the frame 120. Holes are drilled in reproducible positions in the vent, for example with the aid of computer-assisted positioning means such as are currently available for machining devices. No. 10 screws are selected as fasteners, providing that they are accepted by the apertures 200 with sideways clearance of no more than 0.025″ (0.64 mm) and preferably no more than 0.01″ (0.25 mm). The maximum diameter of the aperture allowing an installer to perform a lengthways adjustment, the screws are tightened when the installer is satisfied with the position of the sash 122 in the frame 120.

To assemble a window according to the present invention, the track 12 is attached to the frame 120, with the aid of suitable positioning means. With fasteners 202 selected to be sized appropriately to the mounting apertures 200, the vent bar 34 is attached to the sash 122, again with the use of suitable positioning means. Appropriate sizing of the screws 202 requires that they be accepted by the apertures 200 with a minimum (sideways) clearance of no more than 0.02″ (0.51 mm) and preferably no more than 0.01″ (0.25 mm). Note that the minimum clearance is defined as the clearance between the screw 202 and the vent bar 34 across the width of the aperture 200. The length of the aperture 200, being aligned with the direction of the vent bar 34, is of no consequence for the purposes of this invention. The length of the aperture 200 allows an installer to perform a lengthways adjustment, the screws 202 being tightened when the installer is satisfied with the position of the sash 122 relative to the vent bars 34.

As indicated earlier, each window will have two support brackets 10, one on each side. Note that each vent bar 34 has two mounting apertures 200, one near each end. The preferred clearance of 0.01″ (0.25 mm) applies at each aperture, at which therefore provides a play of ±0.05″ (±0.13 mm). The play between the sash 122 and the frame 120, while determined by the clearance at the apertures 200, will usually be greater than ±0.05″ (±0.13 mm). This is illustrated in exaggerated fashion in FIGS. 6A and 6B. FIG. 6A shows the fasteners 202 centered relative to the aperture widths, while FIG. 6B shows the fasteners 202 off-center in opposite directions. Since the vent bar 34 and, specifically, the spacing between the apertures 200 is typically significantly shorter than the corresponding side of the sash 122, the play at the far end of the sash 122 will be magnified owing to a leverage effect, as is evident from the divergence of the dashed lines of FIG. 6B which represent the alignment of the vent bar 34 and the sash 122. If, as is typical, the side of the sash 122 is about twice the spacing between the apertures 200, the play between the far end of the sash 122 and the frame 120 will be ±0.1″ (±0.25 mm) rather than the ±0.05″ (±0.13 mm) at the apertures 200. This is about one-third of the play in a window supported by a prior art assembly.

In its preferred embodiment, the reduced tolerance window support bracket assembly includes a four bar hinge. However, it may include other types of hinge.

While the invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

What is claimed:

1. An assembly for mounting a vent to a frame, comprising:
(a) a hinge including a vent bar for connection to the vent, the vent bar having a mounting aperture; and
(b) a fastener sized to be at least partially received within the aperture and engage the vent to retain the vent bar relative to the vent, the mounting aperture and the fastener configured to provide a minimum clearance of less than 0.025″ (0.64 mm).

2. The assembly of claim 1, the fastener and the mounting aperture being configured to provide a minimum clearance no greater than 0.01″ (0.25 mm).

3. The assembly of claim 1, the fastener having a diameter of at least 0.185″ (4.70 mm) and the mounting aperture having a width less than 0.215″ (5.46 mm).

4. The assembly of claim 1, the fastener having a diameter of at least 0.185″ (4.70 mm) and the mounting aperture having a width no greater than 0.195″ (4.95 mm).

5. The assembly of claim 1, the fastener having a diameter of at least 0.200″ (5.08 mm) and the mounting aperture having a width no greater than 0.219″ (5.56 mm).

6. The assembly of claim 1, the fastener having a diameter of at least 0.200″ (5.08 mm) and the mounting aperture having a width no greater than 0.215″ (5.46 mm).

7. The assembly of claim 1, the mounting aperture being elongate.

8. The assembly of claim 1, comprising a four-bar hinge.

9. The assembly of claim 1, comprising a non-handed hinge.

10. An assembly for mounting a vent to a frame, comprising:
(a) a hinge including a vent bar for connection to the vent, the vent bar having a mounting aperture with a width; and
(b) a fastener sized to be at least partially received within the aperture and engage the vent to retain the vent bar relative to the vent, the mounting aperture and the fastener being configured to provide a minimum clearance less than 14% of the width of the mounting aperture.

11. The assembly of claim 10, the minimum clearance being no greater than 5.1% of the width of the mounting aperture.

12. The assembly of claim 10, the mounting aperture being elongate.

13. The assembly of claim 10, comprising a four-bar hinge.

14. The assembly of claim 10, comprising a non-handed hinge.

15. A method of engaging a window sash and a frame, comprising:
(a) providing a supporting bracket with a track and a vent bar hingedly connected to the track, the vent bar having a mounting aperture with a width for receiving a fastener;
(b) selecting the fastener to provide a minimum clearance less than 0.025″ (0.64 mm); and
(c) using the fastener to attach the window sash and the vent bar.

16. The method of claim 15, including providing that the minimum clearance is no greater than 0.01″ (0.25 mm).

17. The method of claim 15, including selecting the fastener to have a thickness no less than 0.185″ (4.70 mm) and further providing that the width is no greater than 0.195″ (4.95 mm).

18. The method of claim 15, including selecting the fastener to have a thickness no less than 0.200″ (5.08 mm) and further providing that the width is no greater than 0.219″ (5.56 mm).

19. The method of claim 15, including selecting the fastener to have a thickness no less than 0.200″ (5.08 mm) and further providing that the width is no greater than 0.215″ (5.46 mm).

20. The method of claim 15, including providing that the mounting aperture is elongate.

21. The method of claim 15, including providing that the supporting bracket comprises a four-bar hinge.

22. The method of claim 15, including providing that the supporting bracket comprises a non-handed hinge.

23. A method of engaging a window sash and a frame, comprising:
(a) providing a supporting bracket with a track and a vent bar hingedly connected to the track, the vent bar having a mounting aperture with a width for receiving a fastener;
(b) selecting the fastener to provide a minimum clearance less than 14% of the width of the mounting aperture; and
(c) using the fastener to attach the window sash and the vent bar.

24. The method of claim 23, including providing that the minimum clearance is no greater than 5.1% of the width of the mounting aperture.

25. The method of claim 23, including providing that the mounting aperture is elongate.

26. The method of claim 23, including providing that the supporting bracket comprises a four-bar hinge.

27. The method of claim 23, including providing that the supporting bracket comprises a non-handed hinge.
